(19) United States
(12) Patent Application Publication
(10) Pub. No.: US 2003/0227154 A1
(43) Pub. Date: Dec. 11, 2003

(54) Hand-pull powered scooter

(76) Inventor: Jen-Hsien Yo, Taipei (TW)

Correspondence Address: BACON & THOMAS, PLLC, 625 SLATERS LANE, FOURTH FLOOR, ALEXANDRIA, VA, 22314

(21) Appl. No.: 10/162,983

(22) Filed: Jun. 6, 2002

(51) Int. Cl. B62M 1/16

(52) U.S. Cl. 280/244; 280/253

(57) ABSTRACT

A hand-pull powered scooter comprises a platform body, the front end of which is connected with a headtube shaft; an actuation bar pivotally located at the top of the headtube shaft for swinging movement; a frontfork an upper end of which is inserted into said headtube shaft, a lower end of which is rotatbly pivoted to a front wheel; a gearbox, which includes a plurality of shafts, a plurality of unidirectional gears supported on said shafts, and reduction gears set provided below the platform body; a pair of rear wheels which are rotatably supported on the shaft of the end gear of the gearbox. The lower end of the actuation bar moves a horizontal rack in reciprocative movement via the ends of a plurality of connecting rods. The forward stroke of rack drives a uni-directional gear, and the backward stroke another reverse uni-directional gear, and the rack also drives the end gear in both strokes and both directions.

### FIELD OF THE INVENTION

This invention relates to a hand-pull powered scooter, and particularly to a novel powered scooter structure, in which the swinging movement of actuation bar is utilized to drive indirectly the horizontal rack into reciprocative movement for the driving of end gears in both strokes and both directions, so as to accelerate the rear wheels forward.

### BACKGROUND OF THE INVENTION

Scooter in early stage didn't have a handbar. This causes bad balanced sense and difficulty in manipulation. Because manipulation of scooter needs long-time practicing or high balanced sense, scooter was quite limited to the use as a playing means and prevailing only for youth. Later, it has been prevailing widely to serve as a walking-substitution means after it has been developed to have a handbar and powered structure. Generally, Power source for a conventional powered scooter is either a battery for driving electric motor, or a gasoline engine, or a mechanical means etc. However, battery has heavy-weight, inconvenience in charging, and limited to working-hour problems, while gasoline engine has not only heavy-weight but also noisy, air-pollution and danger in driving problems. Therefore, these negative factors affect the consideration of using them as a means for walking-substitution.

In addition, a Taiwanese new utility model patent No.481160 entitled as “A powered scooter structure”, as shown in FIG. 1, discloses a structure using mechanical means for driving, comprising: a platform frame (10), a powered support bar (20), a front wheel assembly (30), a rear wheel assembly (40), a linkage mechanism (50), and a drive mechanism (60). Said front wheel assembly (30)and rear wheel assembly (40)are provided at the front and rear ends of the platform frame (10) respectively. One end of the powered support bar (20) is pivotally provided at the front end of the platform frame (10), and pivotally connected with one end of the linkage mechanism (50). The other end of the linkage mechanism (50) is connected with the drive mechanism (60) on the rear wheel assembly (40). Swinging movement of the powered support bar (20) actuates the drive mechanism (50) through the movement of the linkage mechanism (50), which in turn puts the rear wheel assembly (40) into rotation so as to generate the momentum for moving forward. The drive mechanism (60) includes: a transmission gear (63), a plurality of passive gears (64), engaged with the transmission gear (63) and fixed onto a fixed seat (61), and a inner gear disc (62) fixed on it. Gear portion (621) is provided on the inside peripheral wall of said inner gear disc (62) for transmission engagement with a plurality of passive gears (64). When the drive mechanism (60) is actuated by the transmission from the linkage mechanism (50), said inner gear disc (62) can move the transmission gear (63) at multiple of gear ratio, to rotate the rear wheels.

In ideal case, the structure of the above disclosure uses the swinging movement of the powered support bar (20) to drive uni-directionally the drive mechanism (60) on the rear wheel assembly (40). In other words, the forward stroke in the pivotal reciprocative movement of said powered support bar (20) can do work, while the return stroke just wastes power. Moreover, said rear wheel assembly (40) can only move forward at constant speed, at the fixed gear ratio of the inner gear disc (62) over the passive gears (64) and the transmission gear (63). No acceleration can be achieved.

### SUMMARY OF THE INVENTION

In view of the disadvantages, especially performance, mentioned above for conventional scooter, it is the object of present invention to provide a hand-pull powered scooter, and particularly to a novel powered scooter structure, in which the swinging movement of actuation bar is utilized to drive indirectly the horizontal rack in reciprocative motion for the driving of end gears in both strokes and both directions, so as to accelerate the rear wheels forward.

The above and other objects can be achieved by a scooter of the present invention, comprising: a platform body which mounted on a pair of longitudinal parallel ribs, and the front end of which is connected with a headtube shaft; a frontfork, with an upper end of which is pivoted and rotates within said headtube shaft, and a lower end of which is rotatably pivoted to a front wheel; an actuation bar, an upper end of which comprises a handbar, and a lower end of which is pivotally located at the top of the headtube shaft for reciprocative swinging; a gearbox, which includes a plurality of shafts, a plurality of unidirectional gears supported on said shafts, and a plurality of reduction gears set, the front end of said gearbox being pivotally mounted on the parallel ribs, the middle end being supported below the parallel ribs via a damping spring; a guide slot provided at the top wall of said gear box; a plurality of connecting rods, the first of which is connected at the lower end of the actuation bar, and the last of which is connected to a horizontal rack; a horizontal rack, inserted into the guide slot of the gearbox, with its teeth meshed with a plurality of unidirectional gears; a pair of rear wheels rotatably supported on the central shaft of the end gear of gearbox.

According to the present invention, during the reciprocative movement of the horizontal rack caused by the pivoting of said actuation bar, the forward stroke of rack drives a unidirectional gear, the backward stroke another unidirectional gear, and the rack also drives the end gear in both strokes and both directions through reduction gears set, so as to accelerate the rear wheels forward continuously. In other words, the rear wheels can move at constant acceleration, when the actuation bar is continuously swinged.

According to the present invention, a ratchet element is pivotally provided on the end gear of the gearbox. The rear wheels rotatably supported on the shaft of the end gear can move in forward direction and stop in reverse direction. Therefore, the rear wheels will not slide downward, even if it is on a slope.

According to the present invention, a pair of brake pedals are provided above the rear wheels and integrally connected together by a plurality of shaft pins. One ends of this pair of brake pedals are pivotally mounted on the parallel ribs of platform body respectively, the other ends being floating, by elastic means, above the rear wheels. The rear wheels can be decelerated or stopped by the friction produced by stepping on the brake pedals. So, the manipulability of this structure is good.

According to this invention, a folded arm is provided between the headtube shaft and the platform body. The folded arm is fixed into position by a pair of elastic pins. Thus, the headtube shaft can be folded relative to the platform body. In addition, the actuation bar has a telescopic structure by the provision of an inner tube. Therefore, it can be folded to save space, when in unused condition.

### BRIEF DESCRIPTION OF ACCOMPANIED DRAWINGS

Above objects, features and advantages of present invention can be further understood by the detailed description of illustrative embodiment of present invention in reference to the accompanied drawings, in which:

FIG. 1 is a structural schematic view of conventional “A powered scooter structure” of Taiwanese new utility model patent No.481160;

FIG. 2 is a perspective view of a hand-pull powered scooter of present invention;

FIG. 3 is a side view of a hand-pull powered scooter of present invention;

FIG. 4 is a plan view of a hand-pull powered scooter of present invention, wherein part of it is exploded to show the structure of a rack and gear group;

FIG. 5 is a cross sectional view taken along the line 5-5 in FIG. 4, wherein the structure of connecting rod, rack and gear group is shown;

FIG. 5a is an enlarged view of FIG. 5, in which part of members are omitted;

FIG. 6 is a schematic view of a hand-pull powered scooter of present invention in folded condition;

FIG. 7 is a schematic sectional view taken along the line 7-7 in FIG. 5, wherein the positioning structure of the elastic pins of the folded arm is shown; and

FIG. 8 is a schematic sectional view taken along the line 8-8 in FIG. 6, wherein the telescopic positioning structure of actuation bar is shown.

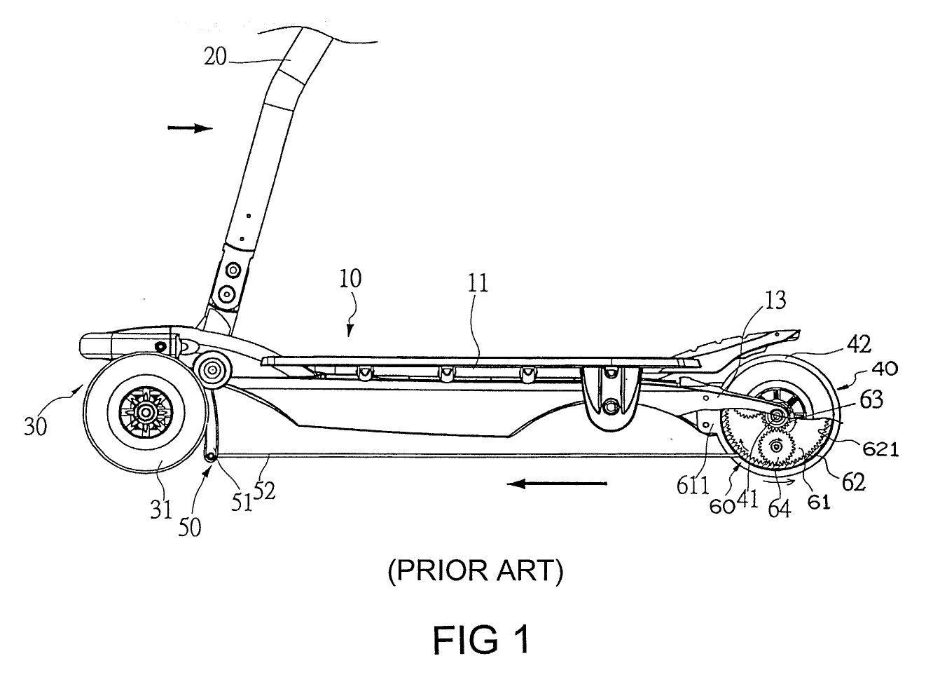

### DETAILED DESCRIPTION OF A PREFERRED EMBODIMENT OF THE PRESENT INVENTION

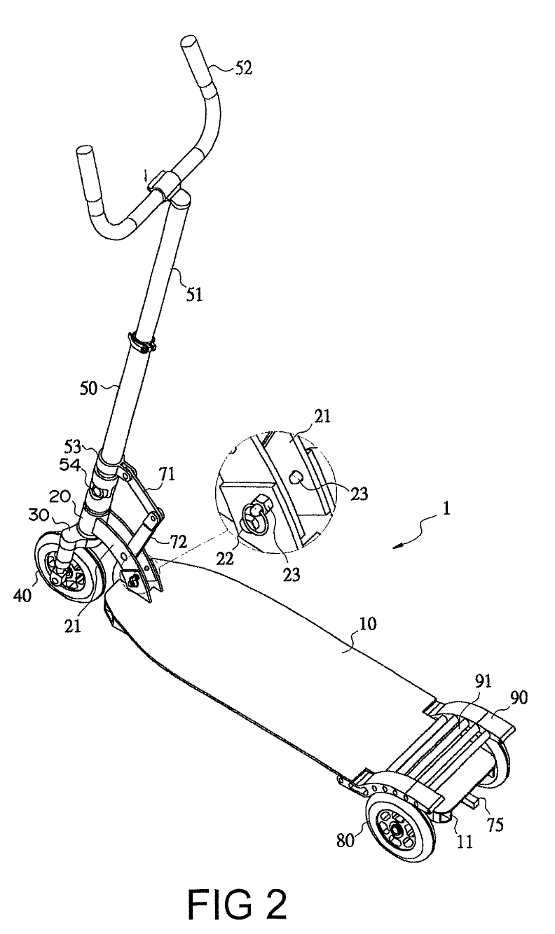

Firstly, referring to FIGS. 2, 3 and 4, a hand-pull powered scooter 1 of the present invention includes: a platform body 10 which is mounted on a pair of longitudinal parallel ribs 11, the, front end of which is connected with a headtube shaft 20; a frontfork 30 an upper end which is pivoted and rotates within said headtube shaft 20, and a lower end which is rotatably pivoted to a front wheel 40; an actuation bar 50, an upper end of which comprises a handbar 52, and a lower end of which pivotally located at the top of the headtube shaft 20 for swinging movement; a gear box 60, including a plurality of shafts 61a, 61b, 61c, 61d for pivotally supporting a plurality of unidirectional gears 62a, 62b, and a plurality of reduction gears set 63a, 63b, 63c, 63d and an end gear 63, the front end of said gearbox 60 being pivotally mounted on the parallel ribs 11, the middle portion of said gearbox being supported below the parallel ribs 11 via a damping spring 68; and a guide slot 65 provided at the top wall of said gearbox 60; a plurality of connecting rods 71, 72, 73, 74, the first connecting rod 71 being connected to a connection piece 53 at the lower end of said actuation bar 50, while the last connecting rod 74 being connected to a horizontal rack 75 in reciprocative motion; said horizontal rack 75 being inserted within the guide slot 65 of the gearbox 60, with its teeth meshed with a plurality of unidirectional gears 62a, 62b; a pair of rear wheels 80 rotatably supported on the axle 61d of the end gear 64 of the gearbox 60.

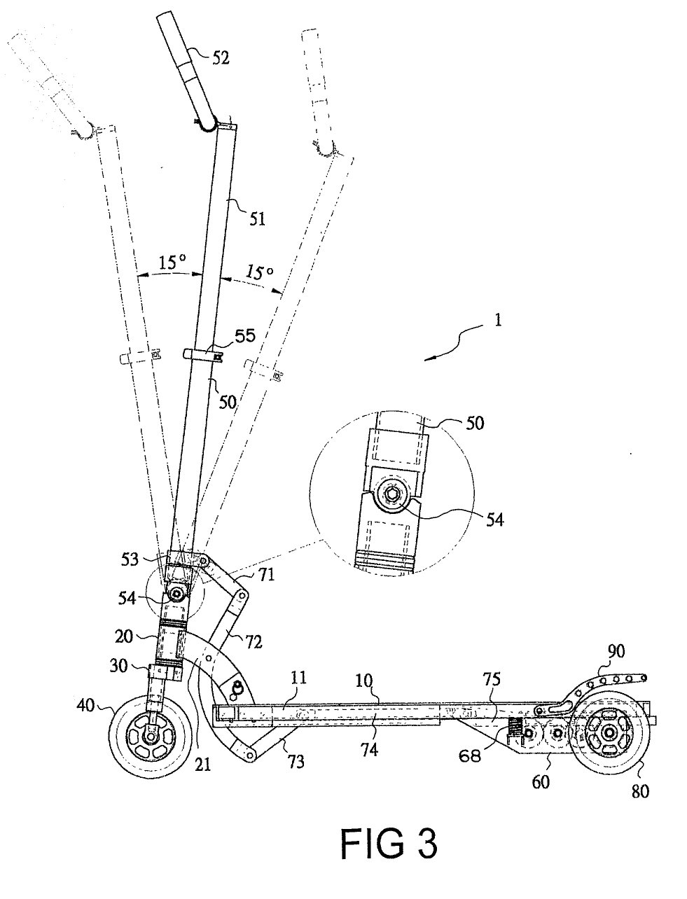

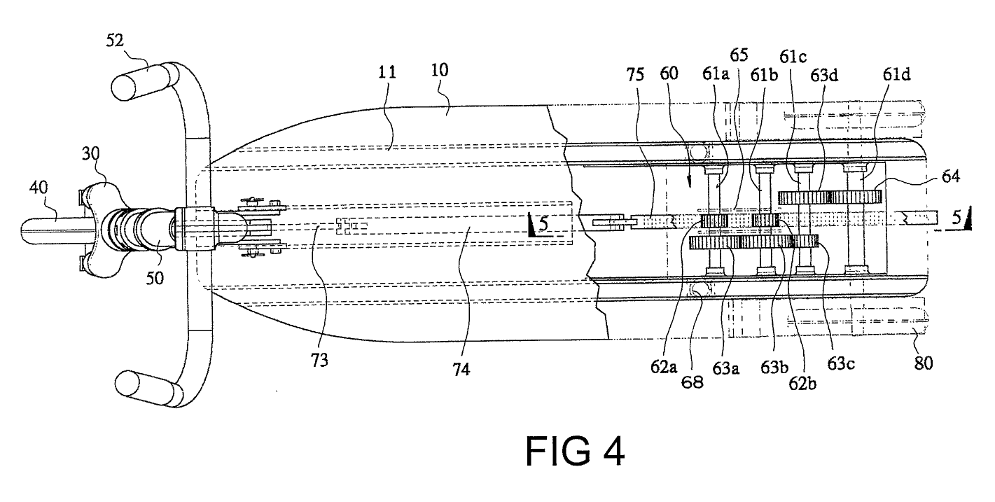

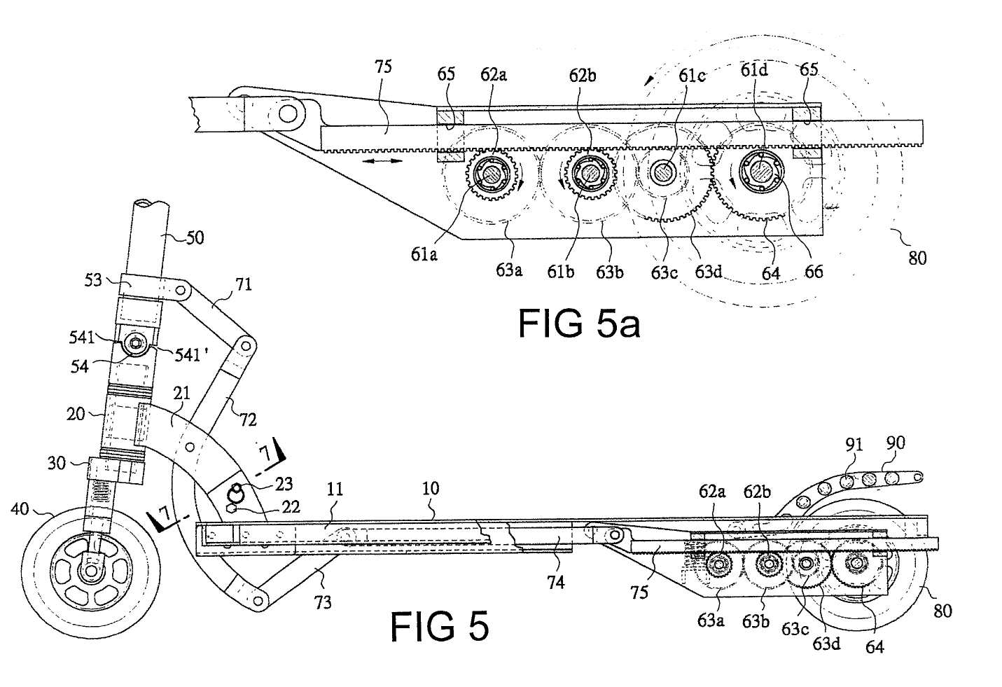

Again, referring to FIG. 4, 5 and 5a, the lower end of the actuation bar 50 of present invention is pivotally located on the top end of the headtube shaft 20 via a universal joint 54, enabling to swinging in forward and backward direction. The swinging angle of the actuation bar 50 in forward and backward direction respectively is approximately between 5°˜25°, preferably 15° (as shown in FIG. 3), which is constrained by the gaps 541 and 541′, so that the swinging extent of an operator's body will not become too large. The lower end of universal joint 54 is connected with frontfork 30, so as to rotate horizontally relative to the headtube shaft 20. In addition, a folded arm 21 is provided between the headtube shaft 20 and the platform body 10, for folding the headtube shaft 20 relative to the platform body 10. A connecting piece 53 is loosely inserted at the lower end of actuation bar 50 therewith, and connecting with a horizontal rack 75 in reciprocative motion via first connecting rod 71, second connecting rod 72, third connecting rod 73, and last connecting rod 74. The teeth portion of the horizontal rack 75 is meshed with that of a unidirectional gear 62a on the shaft 61a, and another reverse unidirectional gear 62b on the shaft 61b. The middle portion of the second connecting rod 72 is pivotally located on the folded arm 21. During the reciprocative moving of the horizontal rack 75, via a plurality of connecting rods 71, 72, 73, 74, caused by the swinging of said actuation bar 50, the forward stroke of movement of the horizontal rack 75 drives a unidirectional gear 62a, while the backward stroke another unidirectional gear 62b, and it also drives the end gear 64 in both strokes and both directions through reduction gears 63a, 63b, 63c, 63d, so as to move the rear wheels 80 forward continuously at constant acceleration(as shown in FIG. 5a). In addition, a ratchet element 66 is pivotally located on the end gear 64. The rear wheels 80 rotatably supported on the shaft of the end gear can move in forward direction and stop in reverse direction. Therefore, the rear wheels 80 will not slide downward, even if it is on a slope.

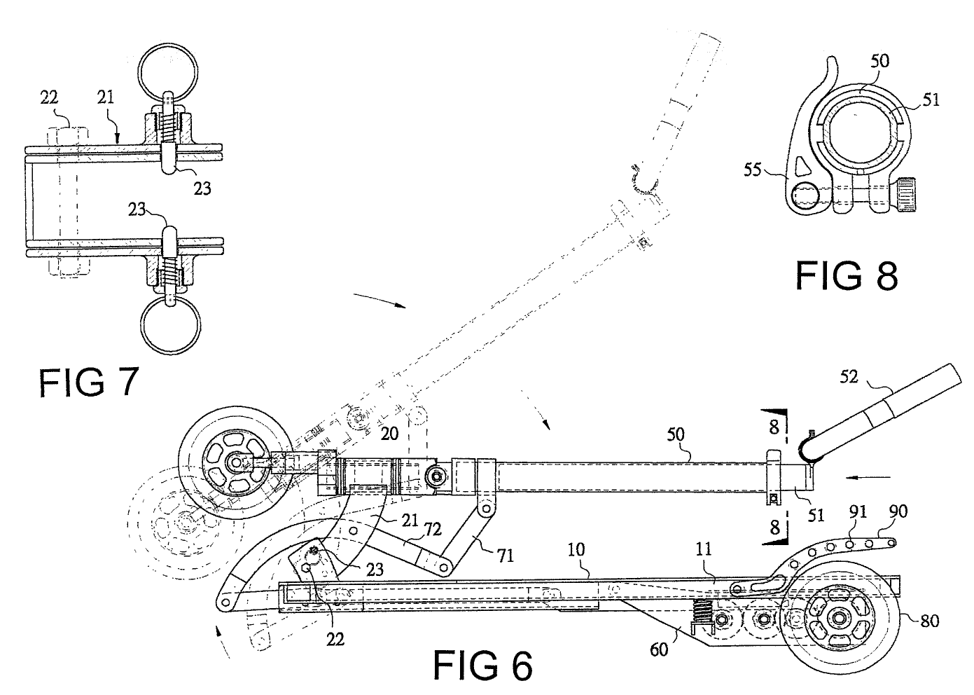

According to the present invention, referring to FIG. 6, a pair of brake pedals 90 are provided above the rear wheels 80 and integrally connected together by a plurality of shaft pins 91. Ends of this pair of brake pedals 90 are pivotally mounted on the parallel ribs 11 of platform body 10 respectively, the other ends being floating, supported by elastic means, above the rear wheels 80. The rear wheels 80 can be decelerated or stopped by the friction produced by stepping on the brake pedal 90. The manipulability of this structure is good.

According to the present invention, a folded arm 21 is provided between the headtube shaft 20 and the platform body 10. The joint of folded arm 21 is pivotally fixed into position by a thread fastener 22. A pair of elastic pins 23 are provided on both side of the joint of folded arm 21 respectively. Thus, the headtube shaft 20 can be folded or extended relative to the platform body 10 by these elastic pins 23. In addition, the actuation bar 50 has a inner tube 51 inserted inside and fastened by a offset retainer 55 to form a telescopic structure (as shown in FIGS. 5 and 6). Therefore, the headtube shaft can be folded to stock or to put into a trunk of car so as to save space when in unused condition.

The above describes a preferred embodiment of present invention without any limitation. Variations and modifications will be readily apparent to those skilled in this art are intended to be included within the scope of this invention and subsequent claims.

Based on the foregoing, the reciprocative strokes of the actuation bar of the hand-pull powered scooter of this invention can drive the end gear in both strokes and both directions so as to accelerate the rear wheels forward continuously. It has good acceration performance, and can be folded to stock to save space when in unused condition. Therefore, this application is novel, inventive, and in abundance of industrial application.

SYMBOL LIST OF COMPONENTS

| | |
|---|---|
| 1 | hand-pull powered scooter |
| 10 | platform body |
| 11 | parallel rib |
| 20 | headtube shaft |
| 21 | folded arm |
| 22 | thread fastener |
| 23 | elastic pin |
| 30 | front fork |
| 40 | front wheel |
| 50 | actuation bar |
| 51 | inner tube |
| 52 | handbar |
| 53 | connecting piece |
| 54 | universal joint |
| 55 | retainer |
| 541, 541′ | gap |
| 60 | gearbox |
| 61a, 61b, 61c, 61d | shaft |
| 62a, 62 | uni-directional gear |
| 63a, 63b, 63c, 63 | reduction gear |
| 64 | end gear |
| 65 | guide slot |
| 66 | ratchet element |
| 68 | spring |
| 71, 72, 73, 74 | connectig rod |
| 75 | horizontal rack |
| 80 | rear wheel |
| 90 | brake petal |

What is claimed is:

1. A hand-pull powered scooter 1, comprising:
a platform body 10, a front end of which is connected with a headtube shaft 20;
an actuation bar 50, a lower end of which pivotally locates at the top of the headtube shaft 20 for swinging movement;
a frontfork 30, an upper end of which is inserted into said headtube shaft 20, and a lower end of which is rotatably pivoted to a front wheel 40;
a gear box 60, which includes a plurality of shafts 61a, 61b, 61c, 61d, a plurality of unidirectional gears 62a, 62b supported on the shafts, and a plurality of reduction gears 63a, 63b, 63c, 63d, and end gear 64, provided below the platform body 10;
a pair of rear wheels 80 which are rotatably supported on the shaft 61d of the end gear 64 of the gearbox 60;
characterized in that:
the lower end of the actuation bar 50 moves together with a horizontal rack 75 in reciprocative movement via the ends of a plurality of connecting rods 71, 72, 73, 74; moreover, during the reciprocative movement of the horizontal rack 75 caused by the swinging of said actuation bar, the forward stroke of rack 75 drives a unidirectional gear 62a, the backward stroke another unidirectional gear 62b, and the movement of the rack 75 also drives the end gear 64 in both strokes and both directions through reduction gears 63a, 63b, 63c, 63d, so as to accelerate the rear wheels forward continuously.

2. A hand-pull powered scooter 1, comprising:
a platform body 10 which is mounted on a pair of longitudinal parallel ribs 11, and the front end of which is connected with a headtube shaft 20;
a frontfork 30, an upper end of wich is pivoted and rotates within said headtube shaft 20, and a lower end of which is rotatably pivoted to a front wheel 40;
an actuation bar 50, an upper end of which comprises a handbar 52, and a lower end of which comprises a universal joint 54 provided at its lower end pivotally located at the top of the headtube shaft 20 for swinging movement;
a gear box 60, which includes a plurality of shafts 61a, 61b, 61c, 61d, a plurality of unidirectional gears 62a, 62b supported on the shafts, and a plurality of reduction gears 63a, 63b, 63c, 63d and an end gear 64, and the front end of which gearbox 60 is pivotally mounted on the parallel ribs 11, middle portion of which gearbox 60 is supported below the parallel ribs 11 via a damping spring 68; and
a guide slot 65 which is provided at the top wall of said gearbox 60;
a plurality of connecting rods 71, 72, 73, 74, in which the first connecting rod 71 is connected at the lower end of said actuation bar 50, while the last connecting rod 74 is connected to a horizontal rack 75, and said horizontal rack 75 is inserted within the guide slot 65 of the gearbox 60, with its teeth meshed with unidirectional gear 62a and a reverse unidirectional gear 62b;
a pair of rear wheels 80 which are rotatably supported on the axle 61d of the end gear 64 of the gearbox 60.

3. A hand-pull powered scooter 1 as claimed in accordance with claim 1 or 2, wherein a ratchet element 66 is pivotally located on the end gear 64, and the rear wheels 80 rotatably supported on the shaft of the end gear can move in forward direction and stop in reverse direction.

4. A hand-pull powered scooter 1 as claimed in accordance with claim 1 or 2, wherein a pair of brake pedals 90 are provided above the rear wheels 80 and integrally connected together by a plurality of shaft pins 91, ends of this pair of brake pedals 90 being pivotally mounted on the parallel ribs 11 of platform body 10 respectively, other ends being floating, supported by elastic means, above the rear wheels 80.

5. A hand-pull powered scooter 1 as claimed in accordance with claim 1 or 2, wherein an folded arm 21 is provided between the headtube shaft 20 and the platform body 10, thereby enabling the headtube shaft 20 to be folded relative to the platform body 10.

6. A hand-pull powered scooter 1 as claimed in accordance with claim 5, wherein said folded arm 21 is fixed into position by a pair of elastic pins 23.

7. A hand-pull powered scooter 1 as claimed in accordance with claim 6, wherein the middle portion of the second connecting rod 72 is supported on said folded arm 21.

8. A hand-pull powered scooter 1 as claimed in accordance with claim 1 or 2, wherein said actuation bar 50 can swing in forward and backward direction with the headtube shaft 20 as the swinging center, with the swinging angle in each direction being approximately between 5°˜25°.

9. A hand-pull powered scooter 1 as claimed in accordance with claim 8, wherein said swinging angle of the actuation bar 50 in forward and backward direction respectively is preferably 15°.

10. A hand-pull powered scooter 1 as claimed in accordance with claim 1 or 2, wherein said actuation bar 50 has an inner tube 51 inserted inside to form a telescopic structure.
